(19) United States
(12) Patent Application Publication
(10) Pub. No.: US 2014/0104561 A1
(43) Pub. Date: Apr. 17, 2014

(54) Method for preventing the loss of eyewear

(71) Applicant: Kerstin Lanier, Asheville, NC (US)

(72) Inventor: Kerstin Lanier, Asheville, NC (US)

(21) Appl. No.: 13/573,217

(22) Filed: Oct. 15, 2012

(51) Int. Cl. G02C 11/00

(52) U.S. Cl. CPC G02C 11/00
USPC 351/43

(57) ABSTRACT

This invention relates to method of preventing eyewear that can consist of sunglasses, glasses, safety glasses, spectacles or any eyewear in general from being lost. Specifically, the invention provides a method for to prevent the eyewear from sinking when dropped in water or other aqueous solutions in which the eyewear will not float.

### FIELD OF INVENTION

This invention relates to method of preventing eyewear that can consist of sunglasses, glasses, safety glasses, spectacles or any eyewear in general from being lost. Specifically, the invention provides a method for to prevent the eyewear from sinking when dropped in water or other aqueous solutions in which the eyewear will not float.

### BACKGROUND OF THE INVENTION

There are literally millions of eyewear that are lost every year as a result of the eyewear falling off an individual's head, being accidentally dropped into water such as at a lake water, beach, ocean, pool, etc., resulting in most cases the permanent loss of the eyewear. As a result this unique invention provides a method to prevent the eyewear from sinking.

There have been other attempts at trying to prevent eyewear from sinking such as making the straps for eyewear installed with floats, many times the eyewear will slip off from the straps, most women do not like wearing straps and straps for eyewear are used mostly for active sportswear. After an extensive search of the patent office's archives the only prior art found of relevance was U.S. Pat. No. 6,513,925 describing snug fitting floating glasses, U.S. Pat. No. 6,059,408 floating eyeglasses (same inventor as the prior), U.S. Pat. No. 5,495,303 again floating glasses (e.g., of which most women would never, ever, wear), U.S. Pat. No. 5,488,441 floating glasses, U.S. Pat. No. 5,319,316 floating glasses, U.S. Pat. No. 4,934,807 floating eyeglasses, U.S. Pat. No. 362,011 floating glasses, U.S. Pat. No. 336,098 eyeglass holder that floats and U.S. Pat. No. 299,034 that illustrates floating glasses. None of the prior art allow the use of any pair of eyewear, regardless of the make, shape, designer and material which can be made of basically anything from metals, plastics, glass, etc., and literally all sink rapidly. The present invention allows the use of the eyewear without the use of a strap or holder. The present invention uses floats that are independent of the glasses frame or structure. The floats slip over the frames preferable between the temples and the ears allowing a comfortable fit for the eyewear. The floats will prevent the glasses from sinking and loss. The floats can be made of any buoyant material (foam, bladder filled with gas or other buoyant material, sponge, etc.). The floats can be of any design shape or color. The floats can be made of a clear material that will not interfere with the appearance of the eyewear or the floats can be made of a bright orange material that can be readily seen. The floats can be slip over the frames that rest around the ears or can be connected by a strap or string or other material and dangle from the frames. They can be made in cute animal forms for kids, etc. The shape, size, make, color and attachment method are unlimited.

The current invention does not have the limitations of the prior art in that the floatation device itself is directly connected to the eyewear. Individuals that purchase sunglasses, glasses for daily use, etc., are not going to wear a pair of glasses that have a floatation device attached for daily use. This is impractical and is illustrated by the lack of availability of the prior art and does not conform to a consumer's society use of sunglasses or eyewear in general.

Given the shortcomings of the prior art, what is needed is a method of preventing eyewear from being lost due to falling in water is something that will actually be used, this invention will prevent the loss of millions of dollars per years in expensive prescription glasses and sunglasses.

### SUMMARY OF INVENTION

The present invention meets the heretofore unfulfilled need of preventing any eyewear from being lost from dropping overboard the side of a boat, at a beach, etc. The present invention allows the use of a wide variety, depending upon the individual's taste, of floats that can be easily slipped over the frames of eyewear to prevent the loss.

In an embodiment, a method of preventing the loss of eyewear: (a) providing a floatation device; (b) this device can be of any shape, size, color or material as long as it is buoyant and will float in water and or other fluid and has enough buoyancy to prevent the attached eyewear from sinking; and (c) such floatation devices are designed to slip over the frames of the eyewear or dangle from straps (e.g. strings, chains, etc., to which the floats are attached) attached to the eyewear on both or just one side of the frame allowing the eyewear to float if dropped into water.

### BRIEF DESCRIPTION OF THE DRAWINGS

For a fuller understanding of the invention, reference should be made to the following detailed description, taken in connection with the accompanying drawings, in which:

FIG. 1 is a perspective view of floats as used on the eyewear.

FIG. 2 is a cross sectional view of the floats on the frame of the eyewear.

### DETAILED DESCRIPTION OF THE PREFERRED EMBODIMENT

In the following detailed description of the preferred embodiments, reference is made to the accompanying drawings, which form a part hereof, and within which are shown by way of illustration specific embodiments by which the invention may be practiced. It is to be understood that other embodiments by which the invention may be practiced. It is to be understood that other embodiments may be utilized and structural changes may be made without departing from the scope of the invention.

The present invention comprises a method for preventing eyewear from sinking once dropped in water or some other fluid. The float(s) attached to the eyewear are usually attached to the frame that rest on the ears between the ears and the corner of the frames. The floats may be of any shape, size and material as long as the floats are buoyant in water. The floats are slid over the frames to rest between the ears and the corner of the frame or can be attached by other means such as a chain, string, tape, pin, etc., or by other attachment means.

Generally a method of preventing eyewear from sinking once dropped in water or some other fluid that the eyewear will not float in. The float(s) attached to the eyewear are usually to the frame that rest on the ears between the ears and the corner of the frames and are of such size not to interfere with eyesight or attachment of the eyewear to the wearer's head. The floats preventing the eyewear from sinking are attached to the eyewear frames presented comprising: (a) a float attach to the frame of the eyewear between the ears and the corner of the eyewear; (b) the float is attached by sliding over the frame to a position between the ears and the corner of the eyewear; and (c) allowing the eyewear to float once dropped in water.

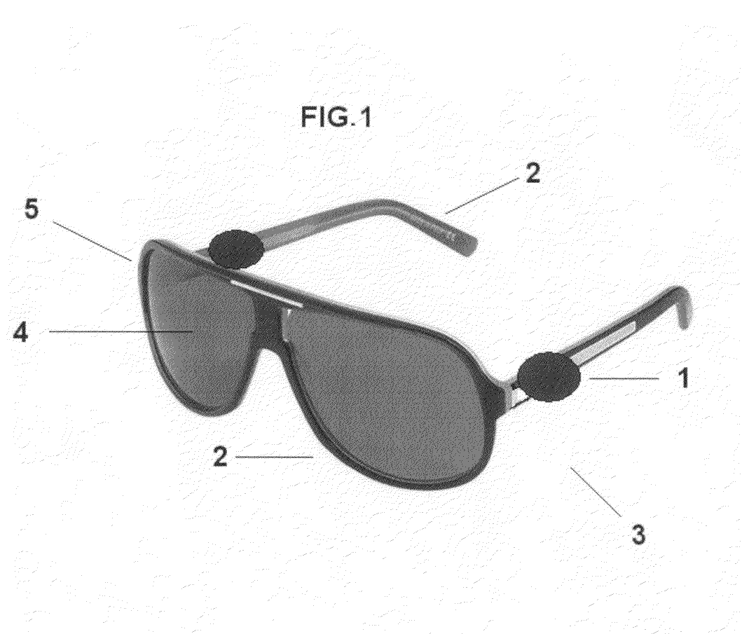

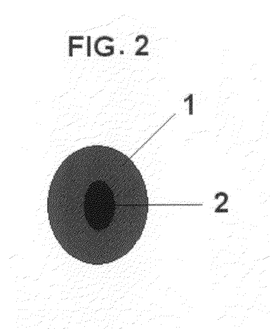

Referring to FIGS. 1-2, a float(s) attached to the eyewear 3 preventing the loss of the eyewear 3 once dropped in waters is presented. The example of eyewear 3 of the present invention generally comprises a frame 2 holding glasses 4 in the frame 2.

Referring to FIGS. 1-2, the floats being made of flexible material can be slid over the end of the frame(s) 2 so that the float(s) 1 will rest between the corner 5 and where the eyewear 3 would rest on the individuals wearing the eyewear's 3 ear.

The material that the float 1 is made of can be made of buoyant material (foam, plastic, wood, bladder filled with gas or other buoyant material, sponge, etc.). The floats 1 can be of any size, design, shape or color, including, but not limited to, foam, rubber, plastic, vinyl or other suitable material that will give the floats 1 enough buoyancy to prevent the eyewear 3 form sinking. Of course this will vary between the size and make of the eyewear's 3 material that the eyewear 3 is made of, etc.

Other materials that may be used to construct the floats 1 are well known by those of ordinary skill in the art.

The floats of the present invention prevents eyewear from sinking once dropped in water thus comprising a method providing floats that can be made of buoyant material that is slid over the frame of eyewear to a position between the ear and corner of eyewear. The float is made up of a buoyant material that will float in water. The float can be made of foam, plastic, wood or other suitable material that is buoyant. The float can be attached by a strap or string or other material and dangle from the eyewear. The float can be of any shape, size, color or material as long as it is buoyant and does not interfere with the vision or comfort of the individual wearing the glasses.

In the preceding specification, all documents, acts, or information disclosed does not constitute an admission that the document, act, or information of any combination thereof was publicly available, known to the public, part of the general knowledge in the art, or was known to be relevant to solve any problem at the time of priority.

The disclosures of all publications cited above are expressly incorporated herein by reference, each in its entirety, to the same extent as if each were incorporated by reference individually.

It will thus be seen that the objects set forth above, and those made apparent from the foregoing disclosure, are efficiently attained. Since certain changes may be made in the above construction without departing from the scope of the invention, it is intended that all matters contained in the foregoing disclosure or shown in the accompanying drawings shall be interpreted as illustrative and not in a limiting sense.

It is also to be understood that the following claims are intended to cover all of the generic and specific features of the invention herein disclosed, and all statements of the scope of the invention that, as a matter of language, might be said to fall therebetween. Now that the invention has been described,

What is claimed is:

1. A method of preventing eyewear from sinking once dropped in water comprising;
a) providing floats comprising
a float that made of buoyant material that is slid over the frame of eyewear to a position between the ear and corner of the eyewear.

2. The method of claim 1, wherein the float is made up of a buoyant material that will float in water.

3. The method of claim 1, wherein the float can be made of foam, plastic, wood or other suitable material that is buoyant. The method of claim 4, wherein the second end of the at least two conduits are angled.

4. The method of claim 1, wherein the float can be attached by a strap or string or other material and dangle from the eyewear.

5. The method of claim 1, wherein the float can be of any shape, size, color or material as long as it is buoyant and does not interfere with the vision or comfort of the individual wearing the glasses.
